(19) United States
(12) Patent Application Publication
(10) Pub. No.: US 2010/0231035 A1
(43) Pub. Date: Sep. 16, 2010

(54) POWER SUPPLY APPARATUS

(75) Inventors: Takenori Tsuchiya, Toyota-shi (JP); Koichi Nagamine, Toyota-shi (JP); Makoto Yoshisato, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi, Aichi-ken (JP)

(21) Appl. No.: 12/280,238

(22) PCT Filed: Feb. 14, 2007
(86) PCT No.: PCT/JP2007/053129

§ 371 Date: Aug. 21, 2008

(30) Foreign Application Priority Data
Feb. 24, 2006 (JP) 2006-048920

(51) Int. Cl. B60L 1/00

(52) U.S. Cl. 307/9.1

(57) ABSTRACT

A power supply apparatus includes a storage battery and a DC/DC converter, and formed such that cooling air having cooled the storage battery cools the DC/DC converter. The power supply apparatus is formed to extend to the periphery of a cabin, and includes a long air outlet duct for letting out part of the cooling air having cooled the DC/DC converter to the periphery; and a short air outlet duct that is formed to have a shorter air outlet route than the long air outlet duct has and that is for letting out part of the cooling air having cooled the DC/DC converter to the cabin.

### TECHNICAL FIELD

The present invention relates to a power supply apparatus. In particular, the present invention relates to a power supply apparatus incorporated in a vehicle.

### BACKGROUND ART

In recent years, electric vehicles employing a motor as a drive source, and what are called hybrid electric vehicles employing a combination of a motor as a drive source and other drive source (such as an internal combustion engine, fuel cells and the like) have been put to practical use. In such vehicles, an electric power storage device for supplying the motor with electric power as the energy is incorporated. As the electric power storage device, for example a secondary battery, a capacitor or the like that can repeatedly be charged and discharged is arranged.

As the secondary battery, a nickel-cadmium battery, a nickel-hydrogen battery, a lithium-ion battery or the like is used. The secondary battery includes a battery module in which battery cells are stacked, for example. The battery module is incorporated in a vehicle as accommodated in a battery case.

The battery module generates heat by an electrochemical reaction in each battery cell and the temperature thereof rises. Since the power generation efficiency of the battery module is reduced at high temperatures, for example, from the outside of the case accommodating the battery module, cooling air is introduced into the case to thereby cool the battery cells. Some power supply apparatuses are provided with an air blowing device such as a fan, a duct and the like for introducing cooling air or warm air inside in order to manage the temperature of the electric power storage device.

The case for accommodating the electric power storage device, the electric power storage device, and other internal components are collectively referred to as a power supply apparatus. In recent years, consideration is given to the arrangement position of the power supply apparatus, and an attempt has been made to arrange the power supply apparatus not outside the cabin but inside the cabin.

Japanese Patent Laying-Open No. 2004-268779 discloses an automobile incorporating an inverter for air cooling, which includes a center console facing a boarding space as a cabin of the automobile and the inverter accommodated in the center console. It also discloses that a battery pack is arranged below a front seat. It further discloses that cooling air supplied to the battery pack is used for cooling the inverter. It further discloses that, as a cooling fan drives, the cooling air is delivered to the battery pack, and the cooling air having cooled the battery pack cools the inverter through a clearance.

It further discloses that the center console can be used as the case covering the inverter and the number of the components of the automobile can be reduced.

Japanese Patent Laying-Open No. 2005-047489 discloses a vehicular electrical equipment unit heating and cooling system, which includes: a vehicular electrical equipment unit including a battery and an inverter unit accommodated in a main air passageway; an air inlet port through which air in a cabin can be introduced into the main air passageway; an air outlet port through which air flowing in the main air passageway can be let out to the outside of the electrical equipment unit; a sub air passageway that can be connected to and shut off from the main air passageway to make a closed circuit when connected to the main air passageway; and a fan for generating a flow of air in the main air passageway.

It is disclosed that, according to the heating and cooling system, when cooling the battery, the air in the cabin is introduced from the air inlet port into the main air passageway, and directed from the battery to the inverter unit, and thereafter let out. Thus, the battery can be cooled efficiently. When heating the battery, the air is circulated in the closed circuit configured by the sub air passageway connected to the main air passageway. Thus, the battery can be heated more efficiently.

In a hybrid electric vehicle or the like, for example the motor generating driving force is sometimes mounted at the engine room on the front side of the vehicle body. A high current of a high voltage flows through the power cable, and therefore it is preferable that the power cable is short. As the cabin is adjacent to the engine room, the power cable can be made short by arranging the power supply apparatus for driving the motor in the cabin. In other cases, for example the power supply apparatus for driving an electric device such as a medical device of an ambulance may be arranged in the cabin.

On the other hand, as described above, the power supply apparatus generates heat and therefore must be cooled. There has been a problem that, when the power supply apparatus is arranged in the cabin, the comfort of the cabin may be impaired due to the cooling air for cooling the power supply apparatus. For example, there has been a problem that the cooling air directly blowing in the passengers makes them feel unpleasantness. In other cases, there has been a problem that enough cooling cannot be achieved if the flow rate of the cooling air is reduced in consideration of impairment of the comfort.

In the vehicular electrical equipment unit heating and cooling system disclosed in Japanese Patent Laying-Open No. 2005-047489, the battery is arranged below the rear seat, and because of the limited space, the cross-sectional area of the passageway of the cooling air is reduced. Thus, there has been a problem that the battery, the inverter unit and the like cannot be cooled enough.

### DISCLOSURE OF THE INVENTION

An object of the present invention is to provide a power supply apparatus that is excellent in cooling capacity and that suppresses impairment of the comfort by the cooling air being let out.

A power supply apparatus of the present invention is a power supply apparatus for an automobile that includes an electric power storage device and an electric device and that is formed to cool the electric device by cooling air having cooled the electric power storage device. The power supply apparatus further comprises a first air outlet device that is formed to extend toward a periphery of a cabin and that is for letting out part of the cooling air having cooled the electric device to the periphery, and a second air outlet device that is formed to have a shorter air outlet route than the first air outlet device has and that is for letting out part of the cooling air having cooled the electric device to the cabin.

In the present invention, preferably, the first air outlet device includes a first air outlet duct, and the second air outlet device includes a second air outlet duct.

In the present invention, preferably, the first air outlet device includes a first air outlet duct, and the second air outlet device is formed to directly let out part of the cooling air having cooled the electric device to the cabin without letting the cooling air pass through a duct.

In the present invention, preferably, the first air outlet device has an air outlet port arranged below a scuff plate of the periphery.

In the present invention, preferably, the second air outlet device has an air outlet port arranged between a floor panel and a floor carpet.

In the present invention, preferably, at least part of the electric power storage device and the electric device is arranged between a driver's seat and a passenger's seat or below the driver's seat and the passenger's seat.

In the present invention, preferably, the electric device includes a device converting electric power.

In the present invention, preferably, the electric power storage device includes at least one of a storage battery and a capacitor.

According to the present invention, a power supply apparatus that is excellent in cooling capacity and that suppresses impairment of the comfort by the cooling air being let out can be provided.

### BRIEF DESCRIPTION OF THE DRAWINGS

FIG. 1 is a schematic perspective view of a cabin in a first embodiment.

FIG. 2 is a schematic perspective view of a power supply apparatus in the first embodiment.

FIG. 3 is a schematic perspective view of an air outlet duct portion in the first embodiment.

FIG. 4 is a schematic plan view of an air outlet duct portion in the first embodiment.

FIG. 5 is an enlarged schematic cross-sectional view of an air outlet port portion of a long air outlet duct in the first embodiment.

FIG. 6 is a schematic cross-sectional view of a center console box portion in the first embodiment.

FIG. 7 is a flowchart related to the flow of air cooling a first battery pack and a DC/DC converter in the first embodiment.

FIG. 8 is a schematic perspective view of an air outlet duct portion of another power supply apparatus in the first embodiment.

FIG. 9 is a schematic perspective view of an air outlet duct portion of a power supply apparatus in a second embodiment.

FIG. 10 is a schematic cross-sectional view illustrating an air outlet duct of the power supply apparatus in the second embodiment.

### BEST MODES FOR CARRYING OUT THE INVENTION

### First Embodiment

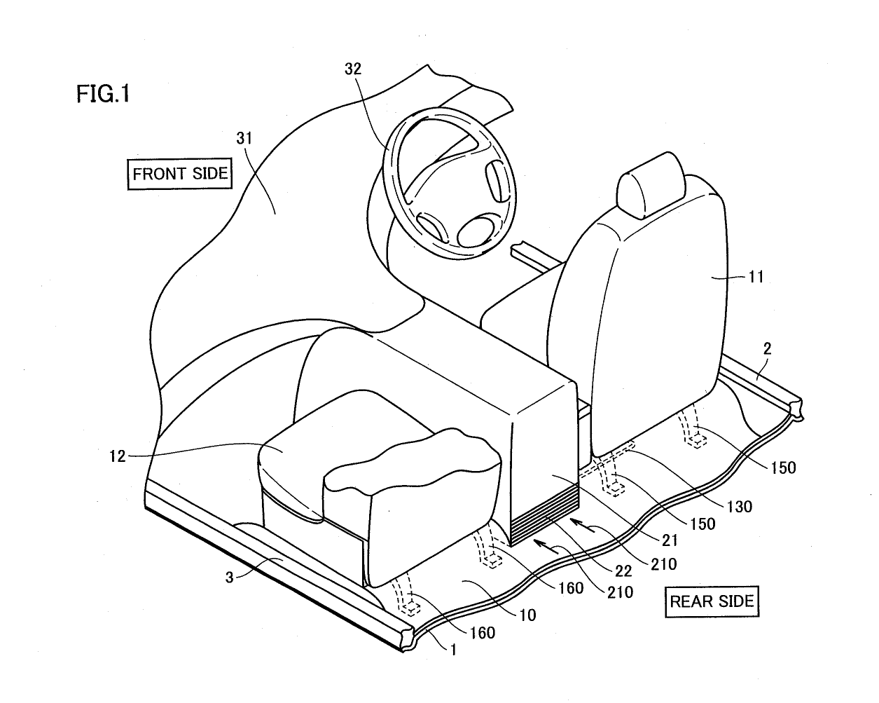

Referring to FIGS. 1-8, a power supply apparatus for an automobile in a first embodiment according to the present invention will be described. In the present embodiment, the substantial portion of the power supply apparatus is arranged in a center console box between a driver's seat and a passenger's seat and below the driver's seat and the passenger's seat.

FIG. 1 is a schematic perspective view of a cabin in the present embodiment. FIG. 1 is a perspective view of the front side portion of the cabin. A dashboard 31 is arranged on the front side of the cabin. A driver's seat 11 and a passenger's seat 12 are arranged as front seats. In front of driver's seat 11, a handle 32 is arranged.

Driver's seat 11 and passenger's seat 12 are fixed to a floor panel 1 by seat legs 150, 160, respectively. On the surface of floor panel 1, a floor carpet 10 is arranged. Seat legs 150, 160 are covered by floor carpet 10. Scuff plates 2, 3 are arranged beside driver's seat 11 and beside passenger's seat 12, respectively. Scuff plates 2, 3 are arranged along the periphery of the cabin. Scuff plates 2, 3 are formed to extend in the front-back direction of the vehicle body.

Between driver's seat 11 and passenger's seat 12, a center console box 21 formed to extend in the front-back direction of the vehicle body is arranged. Center console box 21 is provided at its rear lower portion with an air introducing slit 22 for taking air in the cabin into center console box 21. The air is taken from air introducing slit 22 into center console box 21 as indicated by an arrow 210.

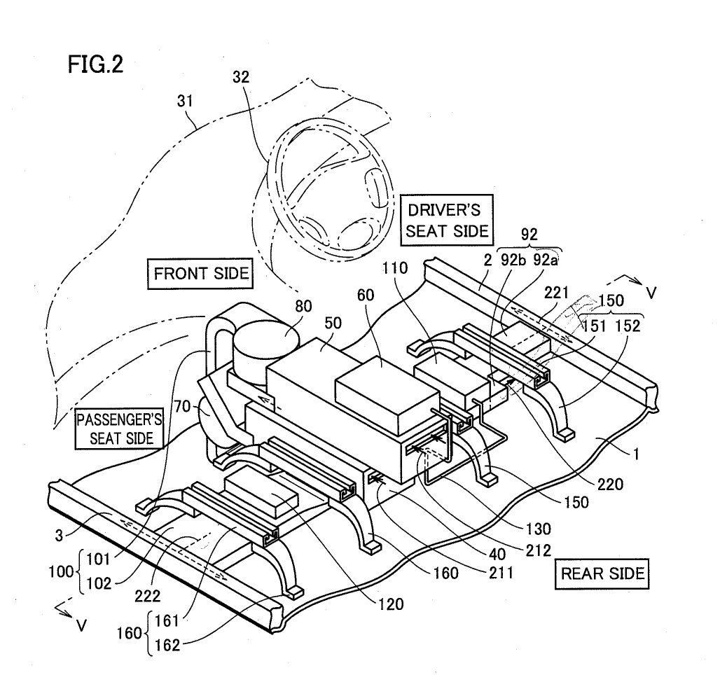

FIG. 2 is a schematic perspective view where the front seats and the center console box are removed, and further the floor carpet is removed.

The power supply apparatus in the present embodiment includes a first battery pack 40. The power supply apparatus includes a second battery pack 50. Second battery pack 50 is arranged above first battery pack 40. Above second battery pack 50, a junction box 60 is arranged. Junction box 60 is electrically connected to a DC/DC converter 110 arranged in the flow path of a first below-seat air outlet duct 92, which will be described later, by a conductor 130.

On the front side of first battery pack 40, a first cooling fan unit 70 is arranged. A first air outlet duct, which will be described later, is connected to first cooling fan unit 70. The first air outlet duct includes first below-seat air outlet duct 92. First below-seat air outlet duct 92 is formed to extend on the driver's seat side. First below-seat air outlet duct 92 is formed to extend in the width direction of the vehicle body.

On the front side of second battery pack 50, a second cooling fan unit 80 is arranged. A second air outlet duct 100, which will be described later, is connected to second cooling fan unit 80. Second air outlet duct 100 includes a second below-seat air outlet duct 102. Second below-seat air outlet duct 102 is formed to extend on the passenger's seat side. Second below-seat air outlet duct 102 is formed to extend in the width direction of the vehicle body.

A pair of seat legs 150 are arranged with a prescribed distance from each other in the width direction of the vehicle body. Seat legs 150 each include a guide rail 151 and semicircular legs 152. Driver's seat 11 is placed on guide rail 151. Driver's seat 11 is supported to be movable in the forward and backward directions. Seat legs 150 extend in the front-back direction of the vehicle body, and has a shape projecting upwardly.

Seat legs 160 have the similar configuration as seat legs 150 do. A pair of seat legs 160 are arranged. Seat legs 160 each include a guide rail 161 and a semicircular legs 162. Passenger's seat 12 is placed on guide rail 161, and supported to be movable in the forward and backward directions.

First below-seat air outlet duct 92 is arranged in a space surrounded by seat legs 150 and floor panel 1. In the air outlet route of first below-seat air outlet duct 92, DC/DC converter 110 implementing an electric device is arranged. First below-seat air outlet duct 92 includes a long air outlet duct 92a and a short air outlet duct 92b. Long air outlet duct 92a is connected to a space surrounded by scuff plate 2 arranged on the driver's seat side and floor panel 1.

Second below-seat air outlet duct 102 is arranged in a space surrounded by seat legs 160 and floor panel 1. In the air outlet route of second below-seat air outlet duct 102, an audio device 120 is arranged. Second below-seat air outlet duct 102 is connected to a space surrounded by scuff plate 3 arranged on the passenger's seat side and floor panel 1.

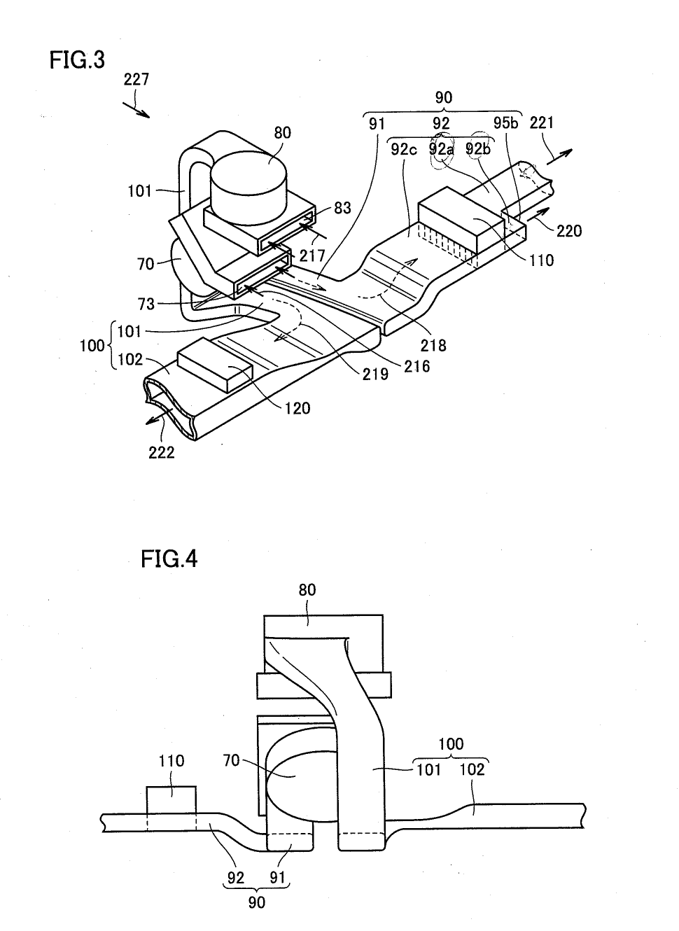

FIG. 3 is a schematic perspective view of a duct through which air is let out from the battery pack in the power supply apparatus. FIG. 4 is a schematic plan view of the duct through which air is let out from the battery pack in the power supply apparatus. FIG. 4 is a view from the front side of the vehicle as indicated by an arrow 227 in FIG. 3.

A cooling device for cooling first battery pack 40 includes first cooling fan unit 70 and first air outlet duct 90. First cooling fan unit 70 is connected to first battery pack 40. The air from first battery pack 40 flows into an air inlet port 73 as indicated by an arrow 216.

First air outlet duct 90 has a first center air outlet duct 91 and first below-seat air outlet duct 92. First center air outlet duct 91 is formed to extend from below first cooling fan unit 70 to below the first battery pack. First center air outlet duct 91 is connected to first below-seat air outlet duct 92.

Part of DC/DC converter 110 arranged in the air outlet route of first below-seat air outlet duct 92 is arranged in first below-seat air outlet duct 92. DC/DC converter 110 is formed to be at least partially in contact with first below-seat air outlet duct 92 so that it is cooled by the air flowing through first below-seat air outlet duct 92.

First below-seat air outlet duct 92 includes long air outlet duct 92a as first air outlet means and short air outlet duct 92b as second air outlet means. First below-seat air outlet duct 92 includes an extending duct 92c. Long air outlet duct 92a and short air outlet duct 92b are arranged on the downstream side of DC/DC converter 110 in the air outlet route. Extending duct 92c is arranged on the upstream side of DC/DC converter 110 in the air outlet route. Extending duct 92c communicates with first center air outlet duct 91.

Short air outlet duct 92b is formed to be shorter than long air outlet duct 92a. Short air outlet duct 92b is formed to have a shorter air outlet route than long air outlet duct 92a has. Short air outlet duct 92b has an air outlet port 95b on the downstream side of DC/DC converter 110. Short air outlet duct 92b is formed to let out the cooling air which have just cooled DC/DC converter 110. Short air outlet duct 92b is formed to be short so as not to substantially affect the flow rate of the air being let out by the pressure loss of the air.

Referring to FIGS. 1-3, air outlet port 95b of short air outlet duct 92b is arranged between floor panel 1 and floor carpet 10. Long air outlet duct 92a is formed to extend to the periphery of the vehicle body. Long air outlet duct 92a is formed to extend toward the sides of the vehicle body. Long air outlet duct 92a extends to scuff plate 2.

FIG. 5 is a schematic cross-sectional view of the scuff plate portion in the long air outlet duct. FIG. 5 is a cross-sectional view along line V-V in FIG. 2. Scuff plate 2 is formed to cover a welded portion 140 of floor panel 1. In the present embodiment, in the space surrounded by floor panel 1 and scuff plate 2, conductor 131 is arranged. Air outlet port 95a of long air outlet duct 92a communicates with the space surrounded by floor panel 1 and scuff plate 2.

Referring to FIGS. 2 and 3, the cooling device of second battery pack 50 includes second cooling fan unit 80 and second air outlet duct 100. Second cooling fan unit 80 is connected to second battery pack 50. The air from second battery pack 50 flows into air inlet port 83 as indicated by an arrow 217.

Referring to FIGS. 3 and 4, second air outlet duct 100 has a second center air outlet duct 101 and second below-seat air outlet duct 102. Second center air outlet duct 101 is formed to extend from second cooling fan unit 80 to below first battery pack 40.

In the air outlet route of second below-seat air outlet duct 102, audio device 120 is arranged. Audio device 120 is placed on the surface of second below-seat air outlet duct 102. Audio device 120 is arranged to be at least partially in contact with second below-seat air outlet duct 102.

Second below-seat air outlet duct 102 is formed to extend toward the sides of the vehicle body. Second below-seat air outlet duct 102 is formed to extend to the periphery of the vehicle body. Referring to FIG. 2, second below-seat air outlet duct 102 is connected to the space surrounded by scuff plate 3 and floor panel 1.

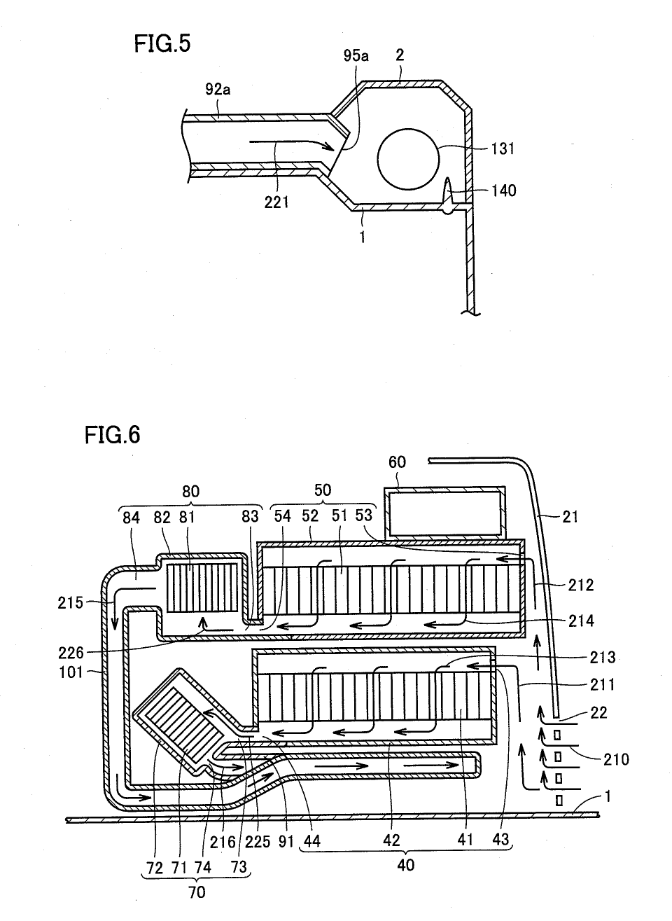

FIG. 6 shows a schematic cross-sectional view of a portion of the center console box in the present embodiment. In center console box 21, first battery pack 40, second battery pack 50, first cooling fan unit 70, second cooling fan unit 80, part of the first air outlet duct and part of the second air outlet duct are arranged. First battery pack 40 and second battery pack 50 are arranged next to each other in the vertical direction.

Referring to FIGS. 2 and 6, first battery pack 40 includes a storage battery 41. Second battery pack 50 includes a storage battery 51. Secondary batteries that can be charged and discharged are employed as storage batteries 41, 51. Storage batteries 41, 51 in the present embodiment include a plurality of battery cells, and formed by the battery cells being stacked. A clearance is formed between each of the battery cells.

First battery pack 40 includes a storage battery case 42. Storage battery case 42 is formed to accommodate storage battery 41 therein. Storage battery case 42 has an air inlet port 43 at its rear-side surface in the front-back direction. Air inlet port 43 is formed at the upper portion of storage battery case 42. Storage battery case 42 has an air outlet port 44 formed for allowing air to flow through first cooling fan unit 70. Air outlet port 44 is formed at the lower portion of its front-side surface.

Second battery pack 50 has the similar configuration as that of first battery pack 40. Second battery pack 50 includes a storage battery case 52, and storage battery 51 is arranged in storage battery case 52. Storage battery case 52 has an air inlet port 53 at its rear-side surface. Storage battery case 52 has an air outlet port 54 formed for allowing air to flow into second cooling fan unit 80.

First cooling fan unit 70 includes a fan case 72. First cooling fan unit 70 includes a sirocco fan 71 as a blower. The sirocco fan is an air blowing fan that takes in the air from the center of the rotary fan along the rotation axis to let out the air in the direction perpendicular to the rotation axis. Sirocco fan 71 is arranged in fan case 72. Sirocco fan 71 is formed such that it can rotate and thereby sends air from storage battery case 42 to first center air outlet duct 91.

Fan case 72 has air inlet port 73. Air inlet port 73 communicates with air outlet port 44 of battery case 42. Fan case 72 has an air outlet port 74. Air outlet port 74 communicates with first center air outlet duct 91.

As sirocco fan 71 drives, negative pressure is established in storage battery case 42. As indicated by an arrow 211, air flows through air inlet port 43 and into storage battery case 42. As indicated by an arrow 213, the air passes through the clearance of storage battery 41, whereby storage battery 41 is cooled. The air having cooled storage battery 41 flows into sirocco fan 71 as indicated by an arrow 225. The air let out from sirocco fan 71 is let out to first center air outlet duct 91 as indicated by an arrow 216.

Second cooling fan unit 80 has the similar configuration as that of first cooling fan unit 70. Second cooling fan unit 80 includes a sirocco fan 81 and a fan case 82. Fan case 82 has an air inlet port 83. Air inlet port 83 communicates with air outlet port 54 of second battery pack 50. Fan case 82 has an air outlet port 84. Air outlet port 84 is connected to second center air outlet duct 101. Sirocco fan 81 is formed such that it can aspirate air from storage battery case 52 and let out the air to second center air outlet duct 101.

Second battery pack 50 is cooled similarly. As sirocco fan 81 drives, air flows inside storage battery case 52 as indicated by arrows 212, 214 to thereby cool storage battery 51. As indicated by arrows 226, 215, the air that has cooled storage battery 51 flows into sirocco fan 81 and thereafter let out to second center air outlet duct 101.

Referring to FIGS. 1 and 6, as indicated by arrow 210, air flows into center console box 21 from air introducing slit 22 formed at center console box 21. The air in the cabin flows into center console box 21 as cooling air. Thus, the air in the cabin cools storage batteries 41 and 51.

Referring to FIG. 3, as indicated by an arrow 218, as first cooling fan unit 70 drives, the air having cooled the storage battery passes through first center air outlet duct 91 and flows into first below-seat air outlet duct 92. The air flows from extending duct 92c toward long air outlet duct 92a and short air outlet duct 92b, whereby DC/DC converter 110 is cooled. Using the air that has cooled the storage battery of the first battery pack, DC/DC converter 110 is cooled.

Part of the air that has cooled DC/DC converter 110 is let out from air outlet port 95b of short air outlet duct 92b, as indicated by an arrow 220. Part of the air that has cooled DC/DC converter 110 is let out between the floor panel and the floor carpet.

Part of the air that has cooled DC/DC converter 110 passes through long air outlet duct 92a and directed toward the periphery of the vehicle body, as indicated by an arrow 221. Referring to FIGS. 2 and 5, the air flow into long air outlet duct 92a is let out to a space surrounded by floor panel 1 and scuff plate 2, as indicated by arrow 221. Referring to FIG. 2, the air flow into the space surrounded by floor panel 1 and scuff plate 2 is dispersed in respective forward and backward directions, as indicated by arrow 221.

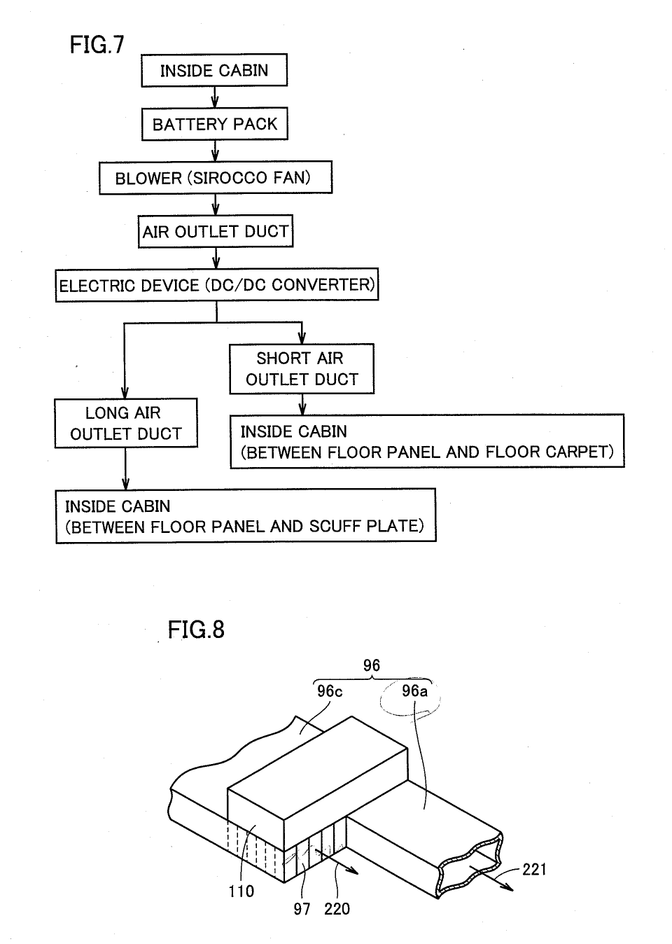

FIG. 7 is a flowchart used for describing the flow of air when the first battery pack and the DC/DC converter in the present embodiment are cooled. As the sirocco fan drives, air flows from the cabin into the battery pack. The air that has cooled the battery pack flows into the sirocco fan. The air let out from the sirocco fan passes through the duct and cools the DC/DC converter as the electric device. Part of the air that has cooled the DC/DC converter passes through the short air outlet duct and let out between the floor panel and the floor carpet. Part of the air that has cooled the DC/DC converter passes through the long air outlet duct and let out between the floor panel and the scuff plate.

Referring to FIG. 3, as second cooling fan unit 80 drives, the air being let out to second center air outlet duct 101 flows in second below-seat air outlet duct 102, as indicated by an arrow 219. The air flows as indicated by arrows 219, 222. The air flowing through second below-seat air outlet duct 102 cools audio device 120.

Referring to FIG. 2, second air outlet duct 100 has second below-seat air outlet duct 102 connected to the bottom side of the scuff plate. The air passing through second below-seat air outlet duct 102 is let out into the space surrounded by scuff plate 3 and floor panel 1, as indicated by arrow 222.

Referring to FIGS. 3 and 7, the power supply apparatus in the present embodiment has, in addition to long air outlet duct 92a formed to extend toward the periphery of the cabin for letting out the air having cooled DC/DC converter 110, short air outlet duct 92b formed to have shorter air outlet route than long air outlet duct 92a has.

Long air outlet duct 92a extends to the periphery of the vehicle body and therefore its air outlet route is long. A great pressure loss occurs in long air outlet duct 92a. The space surrounded by scuff plate 2 and floor panel 1 is small in the flow path cross-sectional area and therefore a great pressure loss occurs. As such, the flow rate for cooling the first battery pack and the electric device may become small. However, in the present embodiment, since short air outlet duct 92b is formed, the pressure loss of the air outlet duct arranged on the downstream side of DC/DC converter 110 can be made small, and enough flow rate of the cooling air can be ensured. Accordingly, the cooling capacity of the storage battery and the electric device can fully be ensured.

Short air outlet duct 92b in the present embodiment has air outlet port 95b arranged between the floor panel and the floor carpet. Long air outlet duct 92a has air outlet port 95a arranged between floor panel 1 and scuff plate 2. This can prevent the air let out by the air outlet duct from directly blowing in the passenger or flow of air from being generated unevenly in the cabin. As a result, the passengers can be saved from feeling unpleasant or feeling discomfort. Thus, the power supply apparatus in the present embodiment can prevent the impairment of comfort by the air being let out.

Furthermore, by adjusting the shape of the long air outlet duct and that of short air outlet duct, the flow rate of the air let out from the long air outlet duct and that let out from the short air outlet duct can respectively be adjusted. For example, by adjusting the cross-sectional area of the air outlet port of the long air outlet port and that of the short air outlet port, the flow rate of the air let out from respective air outlet ducts can be adjusted.

FIG. 8 is a schematic perspective view of an air outlet duct portion of another power supply device in the present embodiment. This another power supply apparatus includes a first below-seat air outlet duct 96. First below-seat air outlet duct 96 has an extending duct 96c and a long air outlet duct 96a. Long air outlet duct 96a extends to the periphery of the cabin.

This another power supply apparatus has an air outlet port 97, and formed so that part of the cooling air having cooled DC/DC converter 110 is let out to the cabin, as indicated by arrow 220. Thus, the second air outlet means may be formed such that air is let out directly to the cabin without being passed through the duct. It is only necessary for the second air outlet means to be formed so that its air outlet route is shorter than that of the first air outlet means.

The electric device in the present embodiment includes a device converting electric power. In the present embodiment, a DC/DC converter is arranged as the electric device. While the device converting electric power generates heat by driving, a power supply apparatus having enough cooling capacity for such an electric device generating great heat can be provided. The device implementing the electric device is not limited to a DC/DC converter and an arbitrary electric device can be arranged. For example, an inverter having an output of 100V for supplying the cabin with AC power may be arranged as the device converting electric power.

The electric power storage device in the present embodiment includes a storage battery. The electric power storage device is not limited to this form, and it is only necessary to be a device that can store electric power. For example, the electric power storage device may be a capacitor.

While the power supply apparatus includes two battery packs and a cooling flow path is formed for each of the battery packs in the present embodiment, the manner is not limited thereto and the electric power storage device can be cooled by an arbitrary manner. For example, a plurality of storage batteries may be stored in one battery case. Alternatively, the air let out from respective battery packs may be unified in one flow path.

While the short air outlet duct is arranged at the cooling path for cooling the first battery pack of the two battery packs in the present embodiment, the manner is not limited thereto and the short air outlet duct may also be formed on the downstream side of the electric device in the cooling path for cooling the second battery pack. For example, the short air outlet duct may be formed on the downstream side of the audio device in the present embodiment.

In the present embodiment, while a cooling structure of the downflow type in which air flow in the battery packs is directed from top to down is exemplarily shown as the cooling structure for the first and second battery packs, the manner is not limited thereto and an arbitrary cooling structure can be employed. For example, a cooling structure of an upflow type in which the air flow in the battery packs is directed from down to top may be employed.

In the present embodiment, at least part of the power supply apparatus for supplying motor with electric power is arranged in the center console box. This configuration enables to shorten the power cable for supplying the motor with electric power, and additionally to provide a wider trunk room for example, as it is not necessary any more to arrange the power supply apparatus in the trunk room. The position of the electric power storage device and the electric device is not limited to this manner, and they can be arranged at an arbitrary position in the cabin such as below the front seats, below the rear seats, and in the luggage room at the rear of the vehicle body.

While ducts are formed to implement air outlet means in the present embodiment, the manner is not limited thereto and it is only necessary to implement the air outlet means by forming an air outlet route. For example, the air outlet route can be formed by forming a groove on the floor and attaching a panel to be the cover. Furthermore, the air outlet means may include a device such as a fan for blowing the air.

### Second Embodiment

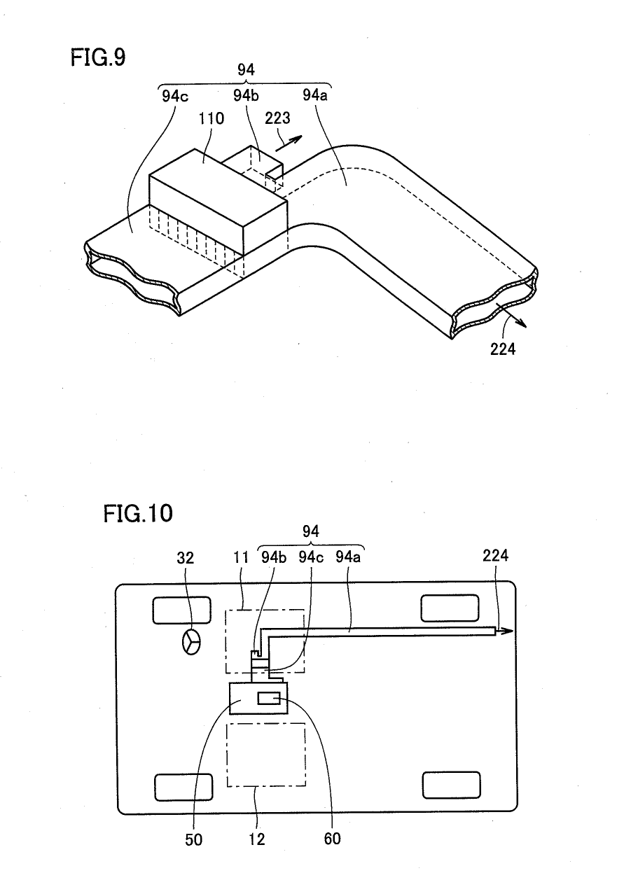

Referring to FIGS. 9 and 10, a power supply apparatus in a second embodiment according to the present invention will be described.

FIG. 9 is a schematic perspective view of an air outlet duct portion of a power supply apparatus in the present embodiment. The power supply apparatus in the present embodiment includes a first below-seat air outlet duct 94. First below-seat air outlet duct 94 includes a long air outlet duct 94a as first air outlet means and a short air outlet duct 94b as second air outlet means. First below-seat air outlet duct 94 includes an extending duct 94c.

FIG. 10 is a schematic cross-sectional view of a vehicle body in the present embodiment. In the power supply apparatus in the present embodiment, long air outlet duct 94a is formed to extend toward the end of luggage room of the periphery of the vehicle body. That is, long air outlet duct 94a is formed to extend toward the rear of the vehicle body. Long air outlet duct 94a has an air outlet port at the end of the luggage room.

Referring to FIGS. 9 and 10, the air having cooled the first battery pack passes through extending duct 94c and cools DC/DC converter 110. Part of the air that has cooled DC/DC converter 110 is let out from air outlet port 94b as indicated by an arrow 223.

Part of the air that has cooled DC/DC converter 110 passes through long air outlet duct 94a and let out from the end of the luggage room, as indicated by an arrow 224. This configuration enables to increase the distance between the position where the passenger sits and the air outlet port of the air outlet means and thereby enables to further improve the comfort. Furthermore, the position where the part of the air having cooled the electric device is let out is not limited to the position below the scuff plate or at the periphery of the luggage room, and can be any position so long as it is at the periphery of the cabin.

Other configuration, function and effect are the same as the first embodiment, and therefore description thereof is not repeated.

In the drawings explained above, the same reference number is allotted to the same or corresponding components.

It should be understood that the embodiments disclosed herein are illustrative and non-restrictive in every respect. The scope of the present invention is defined by the terms of the claims, rather than the description and example above, and is intended to include any modifications and changes within the scope and meaning equivalent to the terms of the claims.

### INDUSTRIAL APPLICABILITY

The present invention is applied to a power supply apparatus. The present invention is particularly advantageously applied to a power supply apparatus incorporated in a vehicle.

1. A power supply apparatus that comprises an electric power storage device and an electric device and that includes a cooling unit, said cooling unit cooling said electric device by cooling air having cooled said electric power storage device and letting out said cooling air, said power supply apparatus being incorporated in a vehicle having a cabin inside, wherein said cooling unit includes
a first air outlet device that is formed to extend from a side of said electric device toward a periphery of said cabin and that is for letting out part of the cooling air having cooled said electric device to said periphery; and
a second air outlet device that is formed to have a shorter air outlet route than said first air outlet device has and that has an air outlet port opened inside said cabin, said air outlet port being for letting out part of the cooling air having cooled said electric device to said cabin.

2. The power supply apparatus according to claim 1, wherein
said first air outlet device includes a first air outlet duct, and
said second air outlet device includes a second air outlet duct.

3. The power supply apparatus according to claim 1, wherein
said first air outlet device includes a first air outlet duct, and
said second air outlet device is formed to directly let out part of the cooling air having cooled said electric device to said cabin without letting the cooling air pass through a duct.

4. The power supply apparatus according to claim 1, wherein
said first air outlet device has an air outlet port arranged below a scuff plate of said periphery.

5. The power supply apparatus according to claim 1, wherein
said second air outlet device has said air outlet port arranged between a floor panel and a floor carpet.

6. The power supply apparatus according to claim 1, wherein at least part of said electric power storage device and said electric device is arranged between a driver's seat and a passenger's seat or below the driver's seat and the passenger's seat.

7. The power supply apparatus according to claim 1, wherein
said electric device includes a device converting electric power.

8. The power supply apparatus according to claim 1, wherein
said electric power storage device includes at least one of a storage battery and a capacitor.

9. A power supply apparatus that comprises an electric power storage device and an electric device and that includes a cooling unit, said cooling unit cooling said electric device by cooling air having cooled said electric power storage device and letting out said cooling air, said power supply apparatus being incorporated in a vehicle having a cabin inside, wherein said cooling unit includes
first air outlet means that is formed to extend from a side of said electric device toward a periphery of said cabin and that is for letting out part of the cooling air having cooled said electric device to said periphery; and
second air outlet means that is formed to have a shorter air outlet route than said first air outlet means has and that has an air outlet port opened inside said cabin, said air outlet port being for letting out part of the cooling air having cooled said electric device to said cabin.

10. The power supply apparatus according to claim 9, wherein
said first air outlet means includes a first air outlet duct, and
said second air outlet means includes a second air outlet duct.

11. The power supply apparatus according to claim 9, wherein
said first air outlet means includes a first air outlet duct, and
said second air outlet means is formed to directly let out part of the cooling air having cooled said electric device to said cabin without letting the cooling air pass through a duct.

12. The power supply apparatus according to claim 9, wherein
said first air outlet means has an air outlet port arranged below a scuff plate of said periphery.

13. The power supply apparatus according to claim 9, wherein
said second air outlet means has said air outlet port arranged between a floor panel and a floor carpet.

14. The power supply apparatus according to claim 9, wherein
at least part of said electric power storage device and said electric device is arranged between a driver's seat and a passenger's seat or below the driver's seat and the passenger's seat.

15. The power supply apparatus according to claim 9, wherein
said electric device includes a device converting electric power.

16. The power supply apparatus according to claim 9, wherein
said electric power storage device includes at least one of a storage battery and a capacitor.
